(19) United States
(12) Patent Application Publication
(10) Pub. No.: US 2025/0001744 A1
(43) Pub. Date: Jan. 2, 2025

(54) COMPOSITE PACKAGING MATERIAL

(71) Applicant: UNIVERSITY OF LIMERICK, Limerick (IE)

(72) Inventors: Maurice COLLINS, Limerick (IE); Mario Culebras RUBIO, Limerick (IE)

(21) Appl. No.: 18/704,696

(22) PCT Filed: Oct. 25, 2022
(86) PCT No.: PCT/EP2022/079821

§ 371 Date: Apr. 25, 2024

(30) Foreign Application Priority Data
Oct. 25, 2021 (GB) 2115326.7

(51) Int. Cl. B32B 27/12; B32B 5/02; B32B 27/18; B32B 27/36; B32B 37/18

(52) U.S. Cl. CPC B32B 27/12; B32B 5/022; B32B 27/18; B32B 27/36; B32B 37/18; B32B 2262/065; B32B 2307/204; B32B 2307/7163; B32B 2317/10; B32B 2367/00; B32B 2553/00

(57) ABSTRACT

A composite material for packaging applications. The composite material comprises lignin, a biodegradable thermoplastic polymer and a fibrous material and may provide a sustainable and readily biodegradable material to be used to form packaging with an improved environmental profile compared to known plastic packaging, without compromising on the performance of said packaging. A method of forming such a composite material and a use of a polymer blend comprising lignin and a biodegradable thermoplastic polymer to form a composite material with a fibrous material are also disclosed.

### FIELD

The present invention relates to a biodegradable composite material for use in packaging applications. The composite material comprises a blend of lignin and polybutylene succinate, and a fibrous material.

### BACKGROUND

Food packaging plays an important role in preserving food throughout the distribution chain. In recent years, the development of novel modified atmospheres and active food packaging has not only increased the shelf life of food, but also its safety and quality. However, such packaging technology must maintain the balance between food protection and other issues, including the costs of energy and materials, heightened social and environmental awareness and stringent regulations on pollutants and disposal of municipal solid waste.

Around 26 million tonnes of plastic waste are generated in Europe every year, according to the European Commission. However, less than 30% of this waste is collected for recycling. 70% of plastic waste is put in landfills or incinerated. According to the statistics, Ireland is the top producer of plastic waste in the European Union, producing 61 kg per person per year compared to the EU average of 31 kg. Within this total of plastic waste, packaging for eggs and fresh fruits and vegetables represent a large proportion.

There are currently available compostable and biodegradable packaging products made from moulded pulp. However, the usage of these materials is constrained due to their shortcomings in waterproof properties, processing complexity and weight.

Lignin is a complex organic polymer present in the cell walls of pith, roots, fruit, buds and bark and, along with hemicellulose and cellulose, is one of the most abundant components of lignocellulosic biomass. Lignin is considered a by-product in the paper and pulp industry and currently only around 2% of total lignin production utilised successfully. Therefore lignin could provide a sustainable source of polymeric material for various applications. However, lignin itself is typically brittle and therefore would perform poorly in packaging applications.

### SUMMARY OF THE INVENTION

The inventors have recognised that in order to improve the processability of lignin in the production of packaging material, the thermoplastic behaviour of lignin-derived materials may need to be increased and the high brittleness of the lignin-derived materials may need to be reduced. The aim of this invention is to solve the problems associated with lignin materials in order to manufacture packaging material with the appropriate mechanical properties for replacing current non-biodegradable and unsustainably produced plastic packaging materials.

It is therefore one aim of the present invention, amongst others, to provide a composite material for use in packaging that addresses at least one disadvantage of the prior art, whether identified here or elsewhere, or to provide an alternative to existing packaging materials. For instance, it may be an aim of the present invention to provide a lignin-based composite material which has improved mechanical properties for packaging applications, for example reduced brittleness and improved flexibility and strength.

According to aspects of the present invention, there is provided a composite material, a packaging item, a method and a use as set forth in the appended claims. Other features of the invention will be apparent from the dependent claims, and the description which follows.

According to a first aspect of the present invention, there is provided a composite material comprising lignin, a biodegradable thermoplastic polymer and a fibrous material.

The composite material is suitably in the form of a packaging material, for example a sheet, film or a wrapper formed of the composite material. Such packaging material may be suitable for enclosing fresh food items and for providing a substantially impermeable barrier around said items.

The inventors have found that the combination of lignin and the biodegradable thermoplastic polymer provides a composition which has improved properties for processing into a packaging material, compared to known compositions comprising only lignin. For example, the composition may be extruded effectively and converted into a film which may then be combined with the fibrous material and formed into a sheet packaging material without breaking, advantageously using conventional equipment and techniques. The composite material so produced may have improved properties which enable its effective usage in packaging applications. It is believed that the biodegradable thermoplastic polymer advantageously modifies the mechanical properties of the lignin to increase the normally low tenacity and flexibility of the lignin sufficiently to allow use as a packaging material. The cost of production of the composite material and packaging produced therefrom may also be advantageously low due to the abundance and relatively low cost of the components of the material and the use of conventional equipment and techniques for producing and processing the composite material. The composite material of this first aspect also provides the potential for the whole composite material to be readily biodegradable and derived from sustainable bio-based feedstocks.

It is believed that any type of lignin can be utilised in the composite material of this first aspect, for example lignin obtained from softwood, hardwood or grass/annual plants. Suitable lignin can be obtained from these sources using various known processes, for example the Kraft, organosolve or soda processes. In some embodiments, more than one type and/or source of lignin is used to provide the lignin of the composite material.

Suitably, at least a part of the biodegradable thermoplastic polymer comprises functional groups which provide compatibility with lignin. Compatibility with lignin may be determined by the polarity of the polymer and/or functional groups within the polymer. Semi-polar polymers may provide acceptable compatibility with lignin. For example, polyester polyols and polyether polyols may have an appropriate polarity for compatibility with lignin. Said semi-polar polymers may provide parts or segments of the biodegradable thermoplastic polymer. Said semi-polar polymers, for example polyester polyols or polyether polyols may provide compatibility with lignin and enable the biodegradable thermoplastic polymer to combine with the lignin to provide a composite material with the improved mechanical properties discussed herein.

In some embodiments, the biodegradable thermoplastic polymer comprises polybutylene succinate. Suitably the biodegradable thermoplastic polymer is polybutylene succinate (PBS).

Suitably the fibrous material of the composite material is a natural fibrous material. Suitably the fibrous material is obtained from a sustainable source. Suitably the fibrous material is biodegradable. Suitably the fibrous material is biodegradable and from a sustainable source.

Suitable natural fibrous materials may be selected from hemp, kenaf, jute, flax, sisal, cotton, coir, kapok and abaca fibres.

Suitably the natural fibrous material is hemp fibres.

Suitably the fibrous material of the composite material is provided as a sheet, suitably a fabric sheet. The sheet of the fibrous material may be a woven or non-woven fabric. Suitably the sheet of fibrous material is a non-woven fabric.

Suitably the fibrous material is a non-woven hemp fabric.

The inventors have found that the mixture of lignin and biodegradable thermoplastic polymer, such as PBS, can be effectively infused into and bound to a fibrous material, such as hemp, to provide composite materials with advantageous mechanical properties for packaging applications. When the fibrous material used is biodegradable, such as hemp, the composite material produced is fully biodegradable, as the lignin and the biodegradable thermoplastic polymer, such as PBS, are also biodegradable. When the fibrous material used is a natural fibrous material and the biodegradable thermoplastic polymer is produced from a biological source, the composite material is suitably fully bio-based. Suitably the components of the composite material are also obtained from sustainable sources. Therefore the present invention may provide a completely biodegradable composite material produced from sustainable, suitably bio-based, feedstocks of lignin, biodegradable thermoplastic polymer and natural fibrous material.

In some embodiments the composite material comprises lignin, PBS and hemp fibres. In such embodiments, the composite material may consist essentially of or consist of lignin, PBS and hemp fibres.

Suitably the lignin is present in an amount of at least 30 wt % of the combined amount of lignin and biodegradable thermoplastic polymer, suitably at least 40 wt %, at least 50 wt % or at least 60 wt % of the combined amount of lignin and biodegradable thermoplastic polymer.

Suitably the lignin is present in an amount of up to 95 wt % of the combined amount of lignin and biodegradable thermoplastic polymer, suitably up to 90 wt %, up to 80 wt % or up to 70 wt % of the combined amount of lignin and biodegradable thermoplastic polymer.

Suitably the lignin is present in an amount of from 30 wt % to 95 wt %, suitably from 40 to 90 wt %, from 40 to 80 wt % or from 50 to 80 wt % of the combined amount of lignin and biodegradable thermoplastic polymer.

Suitably the biodegradable thermoplastic polymer is present in an amount of at least 5 wt % of the combined amount of lignin and biodegradable thermoplastic polymer, suitably at least 10 wt %, at least 20 wt % or at least 30 wt % of the combined amount of lignin and biodegradable thermoplastic polymer.

Suitably the biodegradable thermoplastic polymer is present in an amount of up to 70 wt % of the combined amount of lignin and biodegradable thermoplastic polymer, suitably up to 60 wt %, up to 50 wt % or up to 40 wt % of the combined amount of lignin and biodegradable thermoplastic polymer.

Suitably the biodegradable thermoplastic polymer is present in an amount of from 5 wt % to 70 wt %, suitably from 10 to 60 wt %, from 20 to 60 wt % or from 20 to 50 wt % of the combined amount of lignin and biodegradable thermoplastic polymer.

Suitably the composite material comprises from 40 to 90 wt % lignin and from 10 to 60 wt % biodegradable thermoplastic polymer, based on the combined amount of lignin and biodegradable thermoplastic polymer.

Suitably the composite material comprises from 40 to 90 wt % lignin and from 10 to 60 wt % PBS, based on the combined amount of lignin and PBS.

Suitably the lignin and the biodegradable thermoplastic polymer are thoroughly mixed in the composite material. The lignin and the biodegradable thermoplastic polymer are suitably present in a polymer blend, having the relative amounts of lignin and biodegradable thermoplastic polymer discussed above. The lignin and the biodegradable thermoplastic polymer may be formed into a blend before combining with the fibrous material to form the composite material. Suitably the fibrous material is a sheet of the fibrous material, for example a sheet of hemp material, and the sheet of the fibrous material is fused with a polymer blend comprising the lignin and the biodegradable thermoplastic polymer.

Suitably the fibrous material provides at least 30 wt % of the composite material, suitably at least 40 wt % or at least 50 wt % of the composite material.

Suitably the fibrous material provides up to 90 wt % of the composite material, suitably up to 80 wt % or up to 70 wt % of the composite material.

Suitably the fibrous material provides from 30 to 90 wt % of the composite material, suitably from 40 to 80 wt % or from 45 to 75 wt % of the composite material.

Therefore the combination of the lignin and the biodegradable thermoplastic polymer, suitably in a polymer blend of the lignin and the biodegradable thermoplastic polymer, provides from 10 to 70 wt % of the composite material, suitably from 20 to 60 wt % or from 25 to 55 wt % of the composite material.

Suitably the composite material comprises from 20 to 60 wt % of a blend of the lignin and the biodegradable thermoplastic polymer and from 30 to 90 wt % of the fibrous material.

Suitably the composite material comprises from 20 to 60 wt % of a blend of the lignin and PBS and from 30 to 90 wt % of fibrous hemp material.

Suitably the composite material comprises from 10 to 50 wt % lignin, from 10 to 30 wt % of the biodegradable thermoplastic polymer and from 30 to 80 wt % of the fibrous material.

Suitably the composite material consists essentially or consists of from 10 to 50 wt % lignin, from 10 to 30 wt % of the biodegradable thermoplastic polymer and from 30 to 80 wt % of the fibrous material.

Suitably the composite material comprises from 10 to 50 wt % lignin, from 10 to 30 wt % of PBS and from 30 to 80 wt % of the fibrous hemp material.

Suitably the composite material consists essentially or consists of from 10 to 50 wt % lignin, from 10 to 30 wt % of PBS and from 30 to 80 wt % of the fibrous hemp material.

Suitably the composite material is in the form of a sheet or film, suitably a packaging sheet or film.

Suitably the sheet or film is substantially impermeable to water. Suitably the sheet or film is substantially impermeable to air. Suitably the sheet or film is substantially impermeable to water and air.

Suitably the composite material comprises a sheet of the fibrous material and at least one layer of a blend of the lignin and the biodegradable thermoplastic polymer. Suitably the sheet of the fibrous material is laminated (therefore in a face-to-face arrangement) to the at least one layer of the blend of the lignin and the biodegradable thermoplastic polymer, suitably wherein the polymer blend has penetrated into and has become bonded to the sheet of fibrous material. Suitably the composite material comprises a sheet of the fibrous material and at least two layers of a blend of the lignin and the biodegradable thermoplastic polymer, wherein the sheet of the fibrous material is arranged between the at least two layers of the polymer blend. Therefore the composite material suitably comprises an upper layer of the polymer blend and a lower layer of the polymer blend with the sheet of fibrous material therebetween, suitably laminated together as described above.

In some embodiments, the composite material comprises a dielectric heating susceptor material. This inclusion of a dielectric heating susceptor material suitably allows the use of dielectric heating during formation and/or processing of the composite material, which may provide a more efficient process and/or save energy usage compared to known processes

The polymer blend of lignin and the biodegradable thermoplastic polymer may be relatively unresponsive to dielectric heating, suitably having a dielectric constant of less than 20, suitably less than 10 or less than 5.0.

By dielectric heating susceptor material we mean to refer to a material, for example a particulate material, which absorbs electromagnetic radiation and converts said electromagnetic radiation to heat. For example, the dielectric heating susceptor material may absorb radio frequency radiation and/or microwave radiation and convert said radiation to heat. Suitably the dielectric heating susceptor material absorbs electromagnetic radiation and converts said electromagnetic radiation to heat to a greater extent than the polymer blend, suitably to a much greater extent. Suitably the dielectric heating susceptor material absorbs electromagnetic radiation and converts said electromagnetic radiation to heat to a sufficient extent to heat the polymer blend to a processing temperature.

The dielectric heating susceptor material is suitably selected from any one or more of carbon black, hollow nanospheres, nanotubes, nanofibres, nanosheets, graphene, graphene derivatives and nano/micro hybrids. The dielectric heating susceptor material may also be nanorods, suitably carbon nanorods. These materials may be alternatively or additionally defined as low dimensional particles, for example particles with at least one nanoscale dimension or component.

Suitably the dielectric heating susceptor material is nanoscale particles. Suitably the dielectric heating susceptor material has a particle size in the range of 50 nm to 1,000 nm (measured by transmission electron microscopy (TEM) using standard techniques).

Suitably the dielectric heating susceptor material is formed of carbon nanotubes.

In the context of the present invention, the term “carbon nanotube” refers to a structure conceptually similar to that made by rolling up a sheet of graphene into a cylinder. Depending on the rolling degree and the way the original graphene sheet is formed, carbon nanotubes of different diameter and internal geometry can be formed. Carbon nanotubes formed by rolling up of a single sheet forming the aforementioned cylinder, are called “single-walled” carbon nanotubes (SWCNTs). The carbon nanotubes formed by rolling up more than one sheet of graphene with a structure that resembles a series of concentric cylinders of increasing diameters from the center to the periphery are called “multi-walled” carbon nanotubes (MWCNTs).

Suitably the dielectric heating susceptor material is formed of multi-walled carbon nanotubes (MWCNTs).

In embodiments wherein the carbon nanotubes are multi-walled carbon nanotubes, the multi-walled carbon nanotubes suitably comprise from 2 to 5 graphitic layers.

The carbon nanotubes suitably have a high aspect ratio (length-to-diameter ratio), suitably an aspect ratio of between 10 and 10,000,000 to 1, suitably between 100 and 10,000,000 to 1. The carbon nanotubes are also suitably highly graphitic.

Suitably the dielectric heating susceptor material provides from 0.01 to 0.1 wt % of the composite material.

According to a second aspect of the present invention, there is provided a packaging formed from the composite material according to the first aspect.

Suitably the packaging is in the form of a sheet or film, as described in relation to the first aspect.

The composite material of the packaging of this second aspect may have any of the suitable features and advantages discussed in relation to the first aspect.

According to a third aspect of the present invention, there is provided a method of forming a composite material according to the first aspect, the method comprising the steps of:
a) blending lignin and a biodegradable thermoplastic polymer to form a polymer blend;
b) forming the polymer blend into a sheet of the polymer blend;
c) providing a sheet of the fibrous material;
d) combining the sheet of the polymer blend and the sheet of fibrous material to form the composite material.

Suitably the steps of the method are carried out in the order step a) followed by step b) followed by step c) followed by step d).

The lignin, biodegradable thermoplastic polymer, polymer blend, fibrous material and composite material of the method of this third aspect may have any of the suitable features and advantages described in relation to the first aspect.
Step a) suitably involves extruding the lignin and the biodegradable thermoplastic polymer to form the polymer blend. Powdered forms of the lignin and the biodegradable thermoplastic polymer may be combined in a suitable extruder and extruded together to form the polymer blend. The polymer blend formed by step a) may be in the form of pellets. Extrusion of the polymer blend may take place at elevated temperature, for example at least 100° C., at least 110° C. or at least 120° C. Such extrusion may be carried out at a temperature of from 100 to 140° C.
Step b) may involve hot pressing of the polymer obtained in step a) to produce the sheet of the polymer blend, for example by hot pressing of pellets of the polymer blend produced by extrusion of the lignin and the biodegradable thermoplastic polymer. Hot pressing may be carried out at a temperature of from 120 to 170° C., suitably from 140 to 160° C. Hot pressing may be carried out a pressure of at least 40 KN, suitably at least 50 KN.
Step d) may involve laminating the sheet of the polymer blend and the sheet of fibrous material and subjecting the sheets to hot pressing to produce the composite material. The hot pressing may be as described above for step b). Suitably step d), performed by hot pressing for example, causes the polymer blend to penetrate into and bond with the fibrous material.
Step d) may involve laminating one sheet of the polymer blend and one sheet of fibrous material. Step d) may involve laminating more than one sheet of the polymer blend with one or more sheets of fibrous material. Suitably step d) involves laminating two sheets of the polymer blend with one sheet of fibrous material. Suitably step d) involves laminating a sheet of fibrous material between two sheets of the polymer blend, and then suitably hot pressing to produce the composite material.

According to a fourth aspect of the present invention, there is provided a use of a polymer blend comprising lignin and a biodegradable thermoplastic polymer to form a composite material with a fibrous material, suitably a natural fibrous material.

The polymer blend, lignin, biodegradable thermoplastic polymer, composite material and fibrous material may have any of the suitable features and advantages described in relation to the first aspect.

The use of this fourth aspect is to form a packaging sheet or film. Suitably the use provides an increased tensile strength of the composite material, suitably compared to a composite material comprising lignin and fibrous material. Therefore the use of this fourth aspect may provide the use of a biodegradable thermoplastic polymer, such as PBS, for increasing the tensile strength of a composite material comprising lignin and a fibrous material, such as hemp.

The use may provide an increase in the maximum processing temperature of the composite material, suitably compared to a composite material comprising lignin and fibrous material.

Therefore the use of this fourth aspect may provide the use of a biodegradable thermoplastic polymer, such as PBS, for increasing the maximum processing temperature of a composite material comprising lignin and a fibrous material, such as hemp. Therefore in the use of this fourth aspect, the biodegradable thermoplastic polymer, such as PBS, suitably improves the processability of the polymer blend comprising lignin and the biodegradable thermoplastic polymer in the formation of the composite material.

Suitably the biodegradable thermoplastic polymer, such as PBS, provides an increase in the tensile strength and/or Young's modulus of the polymer blend which provides the improvements in the composite material discussed above.

### BRIEF DESCRIPTION OF THE FIGURES

FIG. 1 show a schematic of the method of forming a composite material of the third aspect of the present invention.

FIG. 2 shows SEM images of lignin/PBS blends as a function of the PBS content.

FIG. 3 shows DSC plots of the Lignin/PBS blends.

FIG. 4A shows a rheology plot for Polymer blend 1.

FIG. 4B shows a rheology plot for Polymer blend 2.

FIG. 4C shows a rheology plot for Polymer blend 3.

FIG. 5 shows mechanical properties of Lignin/PBS blends.

FIG. 6 shows tensile properties of hemp fibre composites.

FIG. 7 shows 3-point bending analysis of lignin/PBS blends and hemp composite samples.

### EXAMPLES

### Materials

Lignin TCA, was obtained from Thecnaro co. (Germany). TCA is an organosolv lignin. PBS was provided by Huaian RuanKe Trade (China).

### Preparation of Lignin/PBS Blends

Polymer blends of lignin and PBS were produced by extruding lignin with a PBS content of from 30 to 50 wt % using an Xplore mircrocompounder MC15. The samples were extruded in order to mix both materials and produce pellets of the polymer blend. The pellets were extruded in a counter-rotating mode using a separated heating control set at temperatures 115, 125, 130, 125° C.

The polymer blends produced in this manner had the following compositions:

Polymer blend 1-70 wt % TCA lignin; 30 wt % PBS.

Polymer blend 2-60 wt % TCA lignin; 40 wt % PBS.

Polymer blend 3-50 wt % TCA lignin; 50 wt % PBS.

### Preparation of Lignin/PBS Sheets

The pellets of the lignin/PBS polymer blend were compressed in hot press at 150° C. under a pressure of 60 KN to produce sheets of the polymer blend for further processing into the composite material.

### Preparation of Lignin/PBS/Hemp Composites

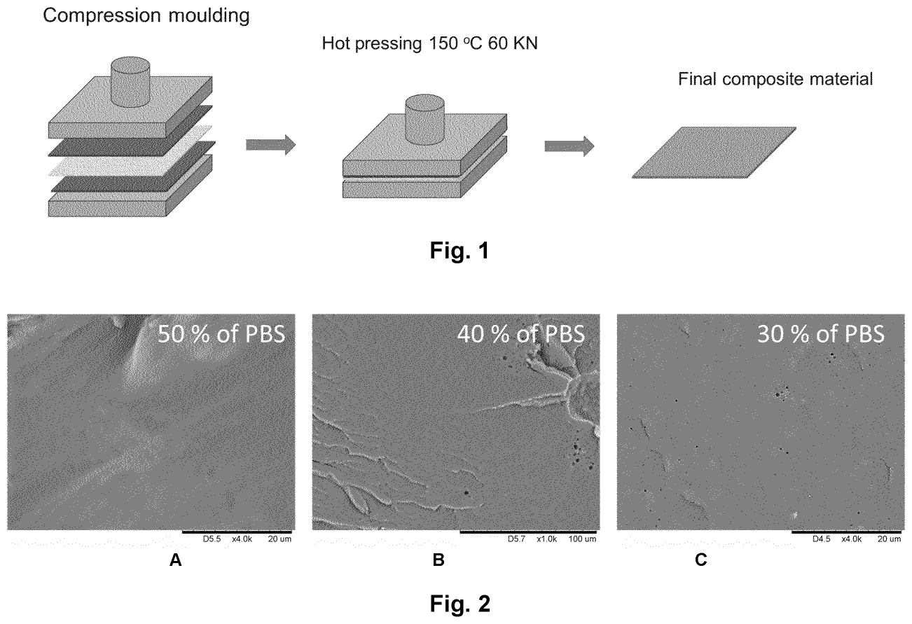

The composites of hemp and lignin/PBS were prepared by compression moulding, as depicted in FIG. 1. Sheets of the polymer blends and sheets of non-woven hemp fibre were placed against each other (face-to-face) in a hot press and then compressed at 150° C. under a pressure of 60 KN, as described above for the preparation of the lignin/PBS sheets.

Either one sheet of the lignin/PBS blends was placed against a sheet of nonwoven hemp fibre to produce a “monolayer” composite material, or two sheets of the lignin/PBS blends were placed against a sheet of nonwoven hemp fibre, one on either side of the sheet of nonwoven hemp fibre, to produce a “bilayer” composite material.

Several example composite materials were prepared in this manner, produced from the number of sheets and having the overall weight percentages of the different components summarized below:

TABLE 1
Composite examples prepared.

| Example | 1 (monolayer) | 2 (bilayer) | 3 (bilayer) |
|---|---|---|---|
| Polymer blend used | 3 | 3 | 3 |
| Sheets of polymer | 1 | 2 | 2 |
| blend | | | |
| Sheets of hemp | 1 | 1 | 1 |
| Hemp fibres (wt %) | 50 | 50 | 70 |
| Polymer blend (wt %) | 50 | 50 | 30 |

### Results and Characterisation

The lignin and PBS polymer blends showed excellent behaviour in terms of processing using extrusion and injection moulding. FIG. 2 shows the SEM images of the lignin/PBS polymer blends as a function of the lignin content. The results indicate a very homogeneous surface with absence of phase separation evidencing a good miscibility between both components. SEM image A shows Polymer blend 3 comprising 50 wt % lignin and 50 wt % PBS, image B shows Polymer blend 2 comprising 60 wt % lignin and 40 wt % PBS and image C shows Polymer blend 1 comprising 70 wt % lignin and 30 wt % PBS.

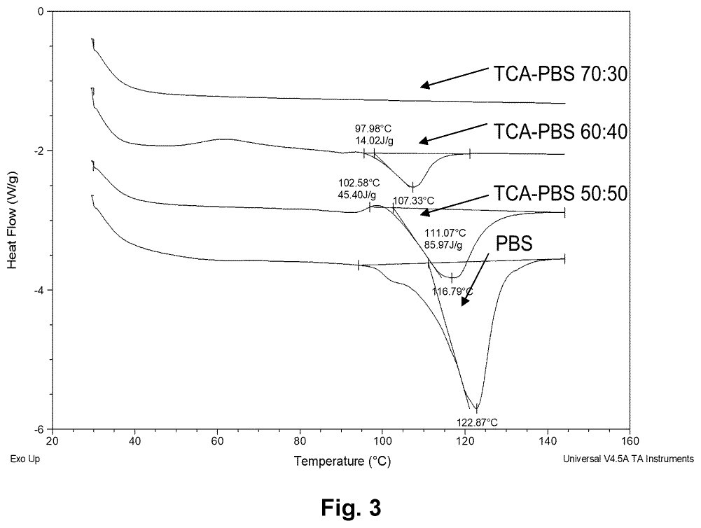

Differential scanning calorimetry (DSC) results for the lignin/PBS blends are shown in FIG. 3. The melting point of PBS clearly decreases with the addition of lignin until it disappears for the Polymer blend 1 comprising 70 wt % lignin. This evidences the good miscibility between lignin and PBS. The absence of a melting point at higher lignin content can be explained by the amorphous nature of lignin and the good miscibility between lignin and PBS which disturbs the crystalline structure of PBS creating a complete amorphous mixture.

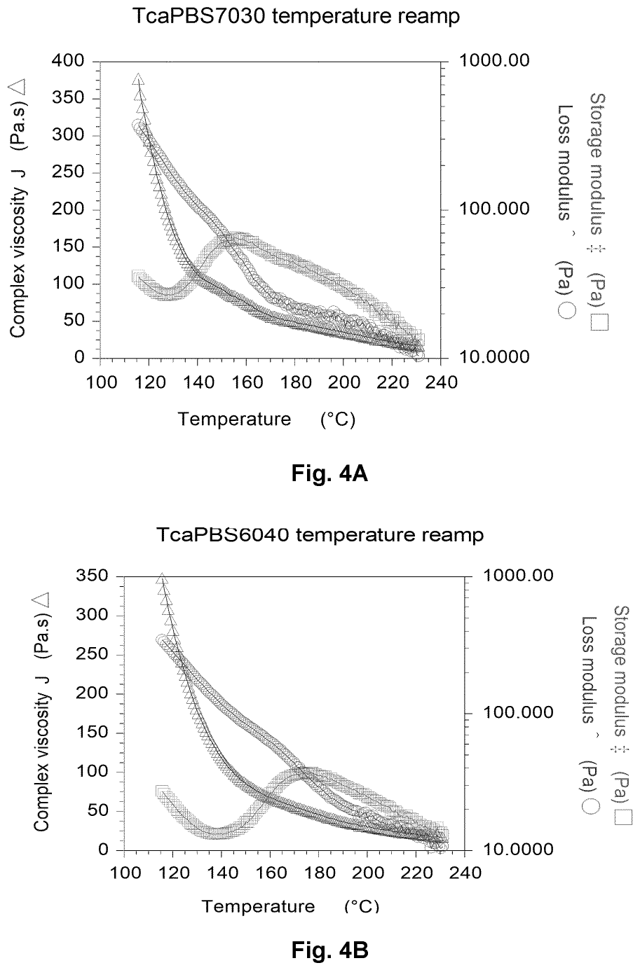

A Rheological analysis was carried out on polymer blends 1, 2 and 3 to determine the thermal processing window of these lignin/PBS blends. The thermal processing widow appears to increase with the addition of PBS as shown by FIGS. 4A-4C. The processing temperatures were 150° C., 170° C. and 190° C. for Polymer blends 1, 2 and 3, respectively. This shows that the processability of the polymer blends improves with higher PBS content.

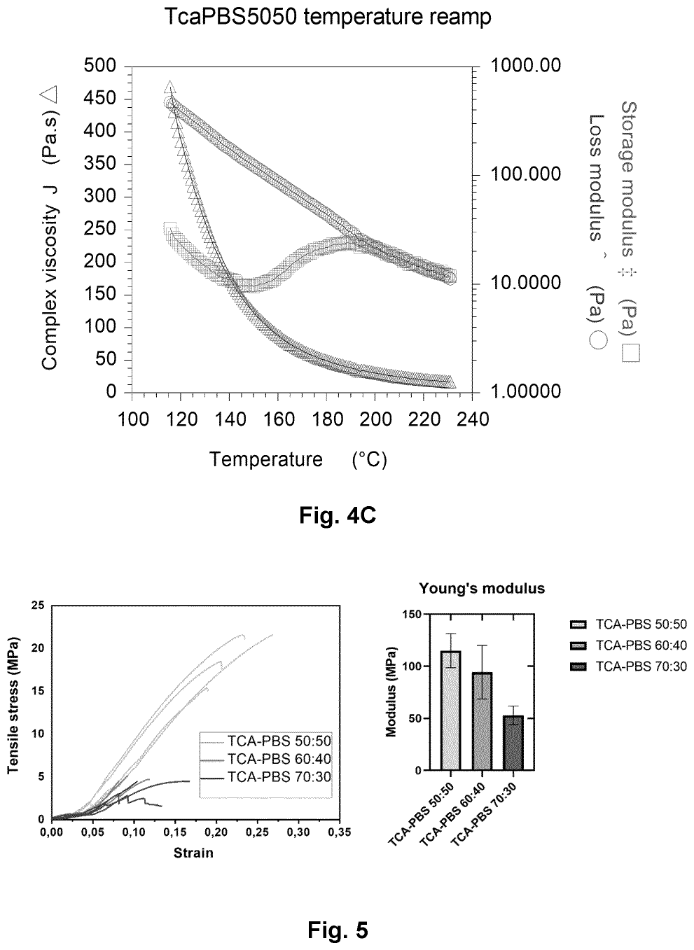

Polymer blends 1, 2 and 3 were tested for tensile stress and FIG. 5 shows the results. The maximum tensile stress and Young's modulus increased as a function of the PBS content, achieving values around 20 MPa of maximum tensile stress and 110 MPa for the Young's modulus of Polymer blend 3 containing 50 wt % lignin and 50 wt % PBS. Again, this shows that the processability of the polymer blends improves with higher PBS content.

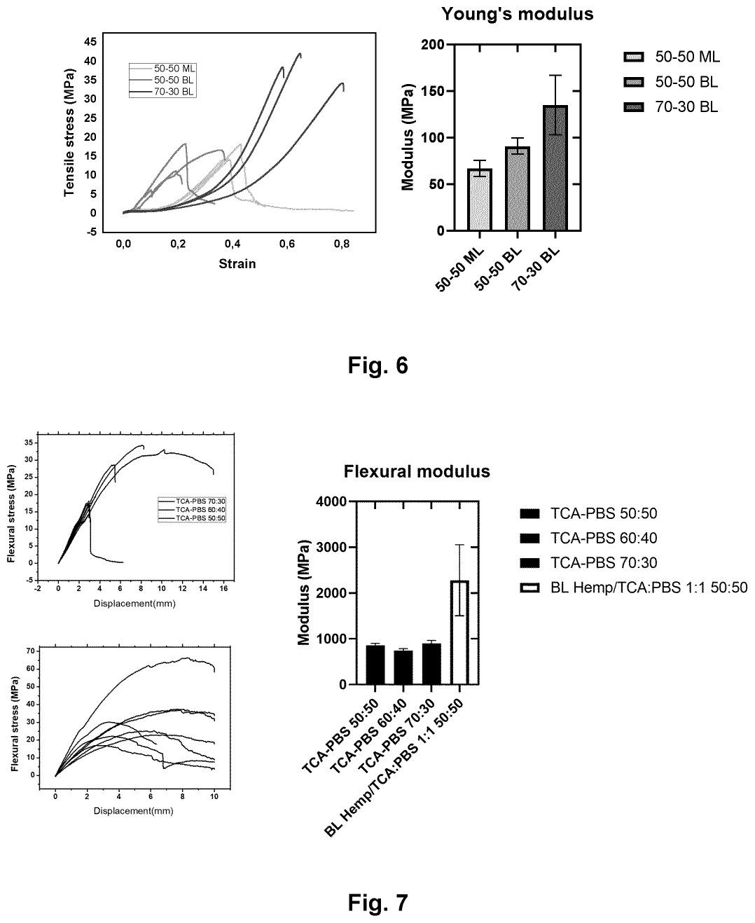

The composite material Examples 1, 2 and 3 were also tested for tensile stress and FIG. 6 shows the results. The values increased with the hemp fibre content. However, the results are in the same order compared to the polymer matrix without fibres, indicating that the stress in the tensile conditions is handled by the matrix of polymer blend.

The samples that showed the best processability were those composed of 50 wt % of fibres and 50 wt % of polymer matrix. All the fibres were impregnated with the lignin/PBS matrix increasing the mechanical integrity of the samples.

The Polymer blends 1, 2 and 3 and composite material Example 2 were also tested under flexural conditions (3-point bending) and the results are shown in FIG. 7. The addition of fibres in Example 2 showed a clear enhancement of the maximum flexural stress and modulus indicating the reduction of brittleness compared to the polymer blends without the hemp fibres.

These results show that the composite materials of the present invention have advantageous mechanical properties for use packaging applications and that the combination of lignin, biodegradable thermoplastic polymer (e.g. PBS) and fibrous material overcomes the unfavourable properties of lignin and allows this abundant, sustainable and readily biodegradable material to be used to form packaging with an improved environmental profile compared to known plastic packaging, without compromising on the performance of said packaging.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt %, this means the weight percentage of the specified component in relation to the whole composition referred to. For example, “the composite material comprises from 40 to 90 wt % lignin” means that from 40 to 90 wt % of the composite material is provided by lignin.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. A composite material comprising lignin, a biodegradable thermoplastic polymer and a fibrous material.

2. The composite material according to claim 1, wherein the biodegradable thermoplastic polymer is polybutylene succinate.

3. The composite material according to claim 1, wherein the fibrous material is a natural fibrous material.

4. The composite material according to claim 3, wherein the natural fibrous material is hemp.

5. The composite material according to claim 1, wherein the lignin and the biodegradable thermoplastic polymer are present in a polymer blend.

6. The composite material according to claim 1, wherein the fibrous material is a sheet of the fibrous material.

7. The composite material according to claim 6, wherein the sheet of the fibrous material is fused with a polymer blend comprising the lignin and the biodegradable thermoplastic polymer.

8. The composite material according to claim 1, wherein the lignin is present in an amount of from 40 to 90 wt % of the combined amount of lignin and biodegradable thermoplastic polymer.

9. The composite material according to claim 1, wherein the biodegradable thermoplastic polymer is present in an amount of from 10 to 60 wt % of the combined amount of lignin and biodegradable thermoplastic polymer.

10. The composite material according to claim 1, wherein the fibrous material provides from 40 to 80 wt % of the composite material.

11. The composite material according to claim 1, in the form of a sheet.

12. The composite material according to claim 1 which is biodegradable.

13. The composite material according to claim 1 comprising a dielectric heating susceptor material.

14. A packaging formed from the composite material according to claim 1.

15. A method of forming a composite material according to claim 1, the method comprising the steps of:
a) blending lignin and a biodegradable thermoplastic polymer to form a polymer blend;
b) forming the polymer blend into a sheet of the polymer blend;
c) providing a sheet of the fibrous material; and
d) combining the sheet of the polymer blend and the sheet of fibrous material to form the composite material.

16. (canceled)
